(19) United States
(12) Patent Application Publication
(10) Pub. No.: US 2012/0200049 A1
(43) Pub. Date: Aug. 9, 2012

(54) CHUCK

(76) Inventor: Johann TAGLANG, Medlingen (DE)

(21) Appl. No.: 13/364,344

(22) Filed: Feb. 2, 2012

(30) Foreign Application Priority Data
Feb. 3, 2011 (DE) 102011000475.0

(51) Int. Cl. B23B 31/18

(52) U.S. Cl. 279/37

(57) ABSTRACT

A chuck has a body rotatable about an axis and formed centered on this axis with a passage. Pivots angularly equispaced about the axis in the chuck body define respective pivot axes. An actuating sleeve axially shiftable in the passage carries a piston disk having a frustoconical outer surface centered on the chuck axis and axially shiftable in the body by the sleeve. Respective shafts journaled in the pivots and rotatable therein about the respective pivot axes each have an outer surface portion that is frustoconical and centered on the respective pivot axis. Respective levers fitted to the frustoconical surface portions of the shafts each have a front arm projecting axially forwardly from the shaft out of the chuck body and adapted to carry a tool-gripping jaw and a rear arm projecting axially rearwardly from the shaft and engageable by the outer surface of the disk.

### FIELD OF THE INVENTION

The present invention relates to a chuck. More particularly this invention concerns a lathe chuck used to turn a workpiece such as a crankshaft while it is being ground.

### BACKGROUND OF THE INVENTION

Such a chuck has a body formed with a passage extending along the chuck rotation axis and receiving an actuating sleeve. An axially displaceable center is detachably secured in the chuck body by a center support. A piston disk interacts with the actuating sleeve and bears with its outer frustoconical surface against rear arms of gripping levers having front arms carrying respective gripping jaws. The gripping levers are mounted for pivoting on a shaft that is pivotable tangentially to the chuck axis.

Such a chuck is shown, for example, in German patent application DE 10 2006 024 637. During the machining of a concentric or eccentric workpiece such as, for example, a crankshaft, the workpiece is gripped at both ends by two power-actuated self-centering lever chucks and is centered on one ends with a fixed center and on the opposite end with an axially movable center. For gripping, the gripping levers of the chuck are pivoted so they abut the surface of the workpiece and clamp it while centering it. For machining the workpiece, it is rotated about the chuck axis. For securely gripping the workpiece, the gripping levers should rest without movement against the workpiece, bearing radially solidly inward thereon.

### OBJECTS OF THE INVENTION

It is therefore an object of the present invention to provide an improved chuck.

Another object is the provision of such an improved chuck that overcomes the above-given disadvantages, in particular that, during constantly changing effective directions of the cutting force, acts with a slip-free and backlash-free gripping force and therefore with an improved gripping force.

### SUMMARY OF THE INVENTION

A chuck has according to the invention a chuck body rotatable about a chuck axis and formed centered on the chuck axis with a passage. A center support on the chuck body carries an axially movable center. A plurality of pivots angularly equispaced about the axis in the chuck body define respective pivot axes all lying in a plane perpendicular to the chuck axis and extending tangentially of a circle centered on the chuck axis and lying in the plane. An actuating sleeve axially shiftable in the passage carries a piston disk having a frustoconical outer surface centered on the chuck axis and axially shiftable in the body by the sleeve. Respective shafts journaled in the pivots and rotatable therein about the respective pivot axes each have an outer surface portion that is frustoconical and centered on the respective pivot axis. Respective levers fitted to the frustoconical surface portions of the shafts each have a front arm projecting axially forwardly from the shaft out of the chuck body and adapted to carry a tool-gripping jaw and a rear arm projecting axially rearwardly from the shaft and engageable by the outer surface of the disk. Thus axial movement of the actuating sleeve shifts the disk against the rear arms and pivots the front arms radially inward to grip a workpiece and center it on the axis.

This has the advantage that the shaft provides a play-free mounting for the gripping levers during rotation of the workpiece with changing effective direction of the main cutting force. By positioning the shaft inside the chuck body, the shaft is additionally protected against contamination occurring during machining.

Furthermore, it is advantageous if a frictional connection is formed between the gripping lever and the shaft extending through the gripping lever. This way, the shaft extending through the gripping levers is self-locking when rotating about the chuck axis, and a rigid structure is created, similar to the one of a casting.

Furthermore, the shaft ends are advantageously formed with radial contact surfaces carrying stop segments for axially securing the gripping lever on both sides. The stop segments thus fix the gripping lever in its longitudinal axis position.

According to the invention the shaft extending through gripping lever has an axial extension on both sides. This extension creates an even better mounting of the gripping levers along the pivot axis. Torques acting on the gripping lever are even better absorbed by this lengthened lever arm.

Furthermore, at least one roller bearing is provided on each shaft extension for rotation of the respective shaft about the respective pivot axis. In this way, the shaft can rotate on the roller bearings, whereby a very smooth movement of the gripping levers during the gripping process is achieved.

Moreover, shaft sleeves comprising a support shoulder and a seat for the shafts and the roller bearing can advantageously be axially positioned on the pivot axis. These support shoulder support the sleeves via stop segments, whereby the axial positioning of the gripping levers on the pivot axis is ensured.

Furthermore, at least one cover cap can be detachably positioned along the pivot axis in the chuck body. This cover cap protects the region in which the gripping lever with the shaft is mounted tangential to the axis against contaminations as can occur during the machining of workpieces. If cover caps are fitted to the right and the left ends of the pivot shafts, these caps create a housing for the gripping lever bearings.

According to another advantage, a roller is assigned to the gripping lever's end actuated by the actuating sleeve via a piston disk. This roller ensures that the gripping levers can be is smoothly and reversibly shifted by spring action from a releasing configuration into a gripping configuration. A potential jamming of the piston disk with the gripping levers is thereby prevented.

Another advantageous embodiment is characterized in that stops for limiting the axial movement of actuating sleeve are provided. These stops limit the movement of the actuating sleeve in both directions along the chuck axis, namely to the front (the opened end of the chuck) and to the back (the closed end of the chuck), which produces a defined angle of the gripping levers to the chuck axis.

Furthermore, it is of advantage if the actuating sleeve is formed from multiple segments or pieces, whereby assembling the chuck is made easier.

### BRIEF DESCRIPTION OF THE DRAWING

The above and other objects, features, and advantages will become more readily apparent from the following description, reference being made to the accompanying drawing in which:

FIG. 1 is a front end view of the chuck according to the invention, the chuck jaws not shown for clarity of view;

FIG. 2 is an axial section through the chuck; and

FIG. 3 is a section taken along line III-III of FIG. 2.

### DETAILED DESCRIPTION

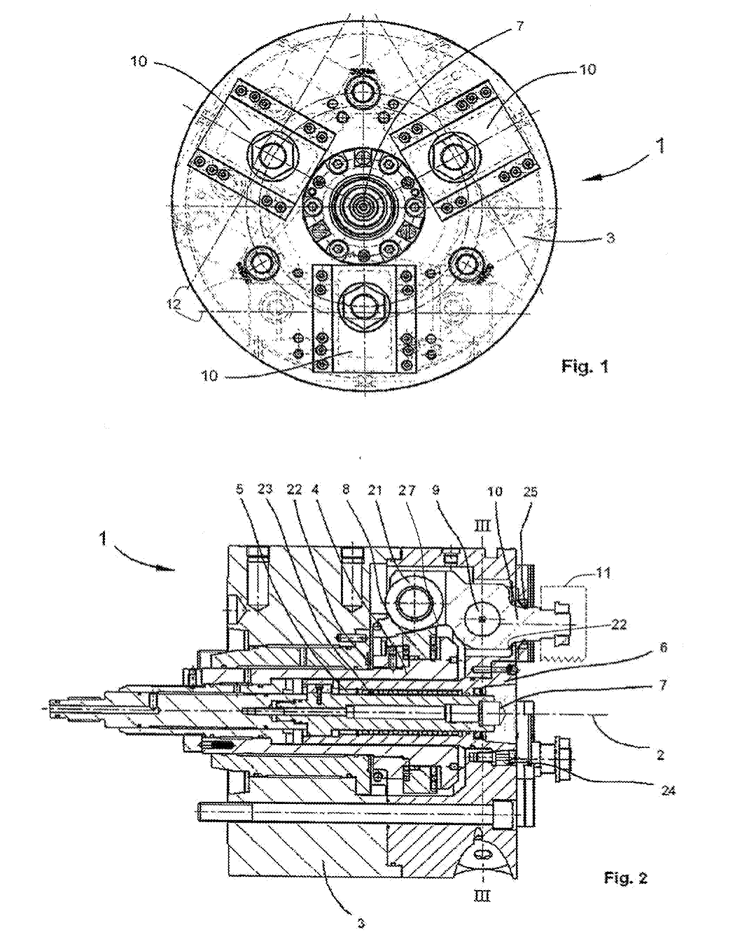

As seen in FIG. 1, a chuck 1 according to the invention has a chuck body 3 rotatable about an axis 2 and carrying three angularly equispaced jaws 11 (one shown in dashed lines in FIG. 2) on respective levers 10. This chuck 1 is intended for use gripping an end of a crankshaft while its bearings and journals are ground.

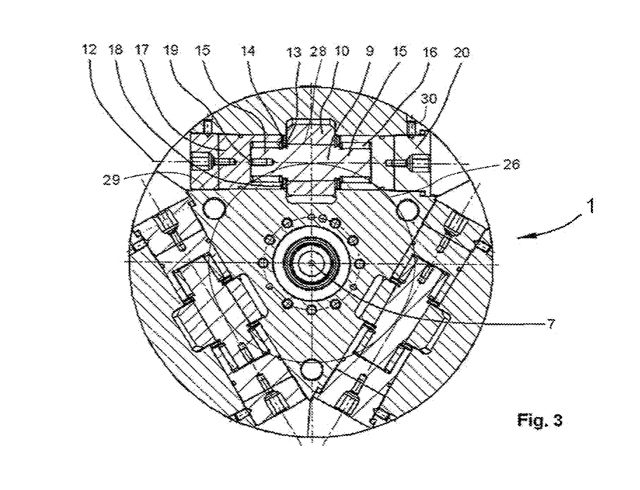

The chuck body 3 is formed centered on the axis 2 (FIG. 2) with an axially extending passage 5 centered on the chuck axis 2 and receiving an actuating sleeve 4, with an axially displaceable center 7 detachably carried in the chuck body 3 on a center support 6. A piston disk 8 carried on the sleeve 4 bears with an outer frustoconical surface 27 that is centered on the axis 2 against rear arms of gripping levers 10 each having a front arm carrying a respective one of the jaws 11. Each lever 10 is mounted for pivoting on a shaft 9 that is pivotal about an axis that lies in a plane III-III and that is pivotal to a circle 26 (FIG. 3 only) centered on the axis 2 and lying in that plane.

Between the center support 6 and the center 7 there is a ball bearing 23 so that these parts can rotate relative to each other about the axis 2. Here, the actuating sleeve 4 interacting with the piston disk 8 is formed from several segments, and a roller 21 is provided on the rear arm of each gripping lever 10 and rides on the frustoconical surface 27 of the disk 8 carried on the sleeve 4. Furthermore, an adjusting device 24 is provided in the chuck body 3, and seals 25 serving as protection against contamination are provided on the front arms of the gripping levers 10. The jaws 11 can grip a concentric or eccentric workpiece. The shaft 9 that supports each lever 10 has a central outer surface portion 27 of frustoconical shape centered on the respective axis 12, and fits with a complementary inner surface of a bore of the respective gripping lever 10, as is apparent from the FIG. 3.

Stops 14, here washers secured to the shafts 9 by snap rings, axially flank and position the respective gripping lever 10 on both axial sides, axially arresting the levers 10 on the respective shafts 9 by engaging respective abutment shoulders 13 thereof. Moreover, each shaft 9 has flanking the large-diameter center part having the frustoconical outer surface 27 two axially opposite cylindrical extensions 15 carried for rotation about the respective pivot axis 12 by cylinder-type roller bearings 16.

The chuck body 3 is formed centered on each of the axes 12 with a secantally throughgoing cylindrical bore 29 holding a pair of cylindrical plugs 18 secured in place by end caps 20 and each formed with an inwardly directed sleeve 17 forming an inwardly open cylindrical seat 19 holding the respective roller bearing 16 supporting the respective shaft extension 15, with the inner ends of the sleeves 17 braced against the stops 14. When assembling the chuck 1, after positioning the inner lever end in place, the respective shaft 9 can be axially of the axis 12 and then secured in place by the plugs 18 and cover caps 20 that are in turn locked by set screws 30 constituting means for securing the cover caps 20 in the bores 2.

The chuck 1 described above is used as follows to grip a workpiece:

The workpiece, in particular a crankshaft, comes to rest with the end against the axially displaceable center 7. If the actuating sleeve 4 is pulled rearward (to the left in FIG. 2) toward the closed end of the chuck 1, it comes into contact with the piston disk 8. This movement of the actuating sleeve 4 can be effected in a mechanical, hydraulic, pneumatic or any other suitable manner. The piston disk 8 is then drawn by the actuating sleeve 4 rearward toward the closed end of the chuck 1. Axial displacement of the sleeve 4 is limited by axially confronting stop faces fixed in the body 3, so that when the sleeve 4 is pulled all the way back and the levers 10 are therefore tipped all the way in with the jaws 11 in the closest position to the axis 2, this position is defined.

This action pivots the rear or inner arms of the levers 10 radially outward relative to the chuck axis 2 by the outer frustoconical surface 27 of the piston disk 8. The gripping levers 10 mounted on the shafts 9 pivot about the respective pivot axes 12. The outer arms of the gripping levers 10 are pivoted radially inward relative to the chuck axis 2 so that the jaws 11 engage the workpiece and, because the piston disk 8 is mounted in a radially floating manner, thereby clamp the workpiece.

I claim:

1. A chuck comprising:
a chuck body rotatable about a chuck axis and formed centered on the chuck axis with a passage;
a center support on the chuck body;
an axially movable center carried in the support on the axis;
a plurality of pivots angularly equispaced about the axis in the chuck body and defining respective pivot axes all lying generally in a plane perpendicular to the chuck axis and extending generally tangentially of a circle centered on the chuck axis and lying in the plane;
an actuating sleeve axially shiftable in the passage;
a piston disk coupled to the sleeve, having a frustoconical outer surface centered on the chuck axis and axially shiftable in the body by the sleeve;
respective shafts journaled in the pivots, rotatable therein about the respective pivot axes, and each having an outer surface portion that is frustoconical and centered on the respective pivot axis; and
respective levers fitted to the frustoconical surface portions of the shafts and each having
a front arm projecting axially forwardly from the shaft out of the chuck body and adapted to carry a tool-gripping jaw, and
a rear arm projecting axially rearwardly from the shaft and operatively engageable by the outer surface of the disk, whereby axial movement of the actuating sleeve shifts the disk against the rear arms and pivots the front arms radially inward to grip a workpiece and center it on the axis.

2. The chuck defined in claim 1, wherein the levers each have between the respective arms a throughgoing bore with a frustoconical inner surface fitting tightly in surface contact with the outer surface portion of the respective shaft.

3. The chuck defined in claim 2, wherein the shaft is formed to both axial sides of the respective outer surface portion with axially directed shoulders, the chuck further including
an abutment or stop carried on each of the shoulders and bearing on a side face of the respective arm, whereby each arm is axially secured between the respective abutments or stops.

4. The chuck defined in claim 2, wherein the shaft has a pair of end extensions extending axially oppositely relative to the respective pivot axis from a center part having the respective outer surface portion.

5. The chuck defined in claim 5, further comprising:
respective roller bearings in the pivots and rotatably carrying the respective end extensions.

6. The chuck defined in claim 5, wherein the chuck body is formed with respective secantally throughgoing bores each aligned with a respective one of the pivot axes and each forming the respective pivot, the chuck further comprising:
a pair of sleeves in each of the bores spaced axially relative to the respective pivot axis, hold a respective one of the respective roller bearings, and surrounding a respective one of the respective shaft extensions; and
respective plugs in the bores each formed with a respective one of the sleeves.

7. The chuck defined in claim 6, further comprising:
respective cover caps in the bores flanking the respective plugs; and
means for axially releasably securing the cover caps in the bores.

8. The chuck defined in claim 1, wherein the rear arm of each lever carries a roller riding on the frustoconical outer surface of the disk.

9. The chuck defined in claim 1, further comprising
stops fixed in the chuck body and limiting axial movement of the actuating sleeve.

10. The chuck defined in claim 1, wherein the actuating sleeve is formed by a plurality of segments.
